(19) United States
(12) Patent Application Publication
(10) Pub. No.: US 2014/0222620 A1
(43) Pub. Date: Aug. 7, 2014

(54) SOCIAL MEDIA REAL ESTATE SYSTEM AND METHOD

(71) Applicants: Stephen M. Polston, Excelsior, MN (US); Jeffery Matthew Colville, Maple Grove, MN (US); Michelle Patrice Hiller, Elk River, MN (US); Joan Marie Skallman, Excelsior, MN (US); Adam E. Lund, St. Louis Park, MN (US); Daniel Scott Cowman, Andover, MN (US); Phil Winkel, Hudson, WI (US); Hector Meneses Hernandez, Plymouth, MN (US)

(72) Inventors: Stephen M. Polston, Excelsior, MN (US); Jeffery Matthew Colville, Maple Grove, MN (US); Michelle Patrice Hiller, Elk River, MN (US); Joan Marie Skallman, Excelsior, MN (US); Adam E. Lund, St. Louis Park, MN (US); Daniel Scott Cowman, Andover, MN (US); Phil Winkel, Hudson, WI (US); Hector Meneses Hernandez, Plymouth, MN (US)

(73) Assignee: PREFERRED HOME BUYERS NETWORK, INC., Excelsior, MN (US)

(21) Appl. No.: 14/169,227

(22) Filed: Jan. 31, 2014

Related U.S. Application Data
(60) Provisional application No. 61/760,474, filed on Feb. 4, 2013.

(51) Int. Cl. G06Q 50/00; G06Q 50/16; G06Q 30/06

(52) U.S. Cl. CPC G06Q 50/01; G06Q 30/0617; G06Q 50/16
USPC 705/26.43

(57) ABSTRACT

A computerized system and method is presented that integrates a dedicated platform for sharing real estate information with a social networking platform. Buyers can search for properties on the dedicated platform and identify certain properties as favorite (or selected) properties. The buyer also identifies their friends on a social networking platform, who then access information about the buyer's favorite properties through an app interface provided through the social networking platform. Friends and the buyer can engage in a conversation about a particular property along with an agent and a lender that work with the buyer on the dedicated platform. Users can participate in and view the conversation either through the app interface of the social networking platform or through the dedicated platform.

### RELATED APPLICATIONS

The present application claims the benefit of U.S. Provisional Patent Application No. 61/760,474, filed on Feb. 4, 2013, which is hereby incorporated by reference.

The present application also relates to content found in the following U.S. patent application Ser. No. 10/187,207, filed Jul. 1, 2002; Ser. No. 11/403,385, filed Apr. 12, 2006; Ser. No. 11/999,299, filed Dec. 4, 2007 (now U.S. Pat. No. 8,095,457, issued on Jan. 10, 2012); Ser. No. 13/040,314, filed Mar. 4, 2011; Ser. No. 13/071,828, filed Mar. 25, 2011; and Ser. No. 13/346,132, filed Jan. 9, 2012. Each of these related applications is hereby incorporated by reference.

### FIELD OF THE INVENTION

This application relates to the field of automated systems that assist in the marketing of residential real estate. More particularly, the described embodiments provide integration between a dedicated computerized platform and a social media computerized platform.

### SUMMARY

A system in one embodiment of the present invention provides a dedicated data platform server, such as a website server, that is accessible by potential buyers of real estate, real estate agents, and mortgage lenders. Buyers who desire to research real estate listings are entered into the system and associated in the data maintained by the system with an agent. That agent is associated in the system with a particular lender, who is responsible for activating a buyer's search criteria before the buyer can search real estate listings at the dedicated platform server.

The potential buyer may share selected properties with friends, relatives, and co-workers through a social networking platform that is operated separately from the dedicated platform. The friends access information about the potential buyer's selected properties through an app interface provided by the social networking platform. The social networking platform may take the form of the Facebook platform (provided by Facebook, Inc. of Cambridge, Mass.) or any other social networking platform. The “apps” can be separate computer applications that interact with the social networking platform, or specially designed applications that function only within the frameworks provided by the social network platform. Friends can submit comments about the properties to the potential buyers. Furthermore, the potential buyer can engage in an electronic conversation about properties with their friends, their real estate agent, and their mortgage lender. The potential buyer, agent, and lender can access this conversation through the dedicated platform, while the friend's access the same conversation through the interface provided by the social networking platform. In some embodiments, the buyer, agent, and lender can also access the conversation through their own accounts on the social networking platform. Finally, friends invited to participate in the conversations will be presented with the opportunity to communicate with the potential buyer's agent and lender through the social networking platform, and to request access to the search capabilities of the dedicated platform.

### BRIEF DESCRIPTION OF THE DRAWINGS

FIG. 1 is a block diagram showing the major parties using a computerized system that operates the described embodiments of the present invention.

FIG. 2 is a block diagram showing one or more server computers maintaining a computerized database to operate a dedicated platform server in order to present interfaces over the Internet and to interact with a social networking platform.

FIG. 3 is a schematic diagram showing a buyer interface created on a dedicated platform.

FIG. 4 is a diagram showing a social networking conversation interface.

FIG. 5 is a schematic diagram showing a buyer app interface created by an app running in a canvas that is presented within a social networking platform interface.

FIG. 6 is a schematic diagram showing a friend app interface created by the app of FIG. 5.

FIG. 7 is a schematic diagram showing an agent interface created on the dedicated platform.

FIG. 8 is a schematic diagram showing a lender interface created on the dedicated platform.

FIG. 9 is a flow chart showing a method of implementing one embodiment of the present invention.

FIG. 10 is a schematic diagram illustrating a variety of conversations of differing topics that could be associated with a buyer.

FIG. 11 is a block diagram showing a single user of a dedicated platform server communicating with a single user of a social networking platform using a social networking platform app.

### DETAILED DESCRIPTION

### Basic Configuration

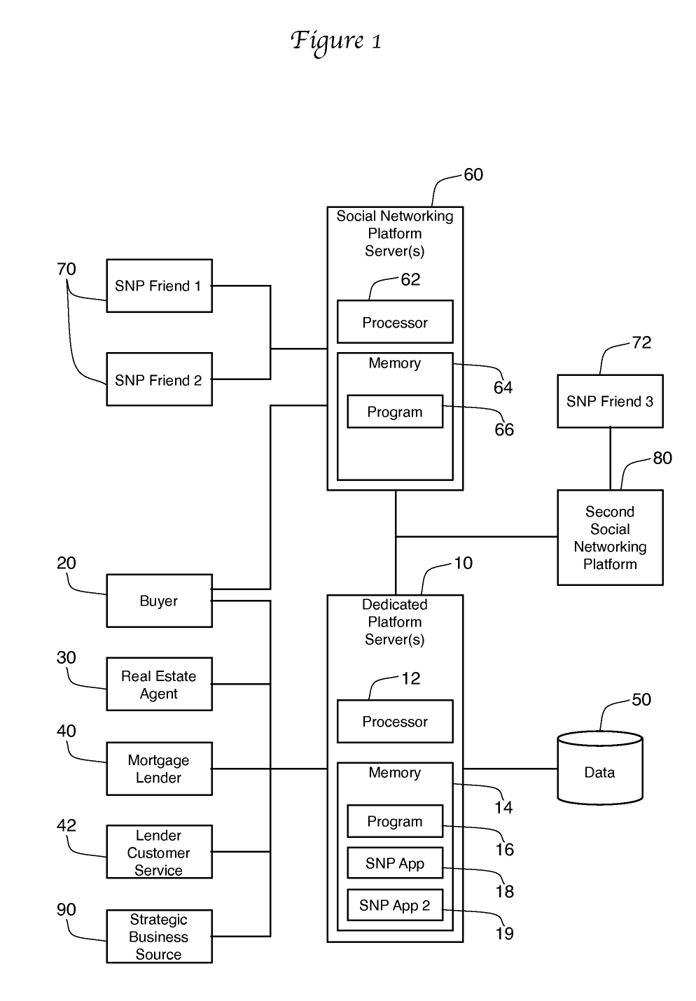

FIG. 1 is a block diagram of one embodiment of the present invention, showing a computerized system 10 for facilitating communication and business relationships between the various parties involved in the marketing and sale of real property. The computerized system 10 is designed to work with a potential buyer of real estate 20, a real estate agent 30 working with the buyer 20, and a mortgage lender 40 who works with both the real estate agent 30 and the buyer 20.

The computerized system 10 includes a digital processor 12 and a non-transitory, tangible memory device 14, such as a hard drive, RAM, PROM, flash memory, or some other form of programmable, physical memory. Residing on the memory 14 is a program 16 consisting of a set of instructions and interfaces for execution on the digital processor 12. In one embodiment, the memory 14 consists of non-transitory memory as well as transitory memory such as RAM. In these embodiments, the permanently stored programs 16 residing on the non-transitory memory are first loaded into transitory RAM before being processed by the processor 12. Similarly, data can be stored in non-transitory memory and copied into RAM for processing by the processor 12. The processor 12 could be a microprocessor manufactured by Intel Corporation of Santa Clara, Calif., or Advanced Micro Devices, Inc. of Sunnyvale, Calif.. Alternatively, the computerized system 10 could be a network of computers all operating according to the instructions of the computer program 16. The various parties 20, 30, and 40 that use the computerized system 10 communicate with the system 10 through a wide area network such as the Internet.

In one embodiment, the computerized system 10 provides a dedicated platform by using the computer program 16 to operate as a web server. The buyer 20, agent 30, and the lender 40 access the program 16 through a web browser operating on local computing devices attached to the Internet. In another embodiment, the computerized system provides the dedicated platform by using the computer program 16 to operate as a data server that interacts with applications by receiving data queries and provides the data requested by the queries. The buyer 20, agent 30, and the lender 40 operate applications on computing devices that interact with the computerized system 10. In some embodiments, these applications run on computer operating systems, such as MAC OS (from Apple Inc. of Cupertino, Calif.) or WINDOWS operating system (from Microsoft Corporation of Redmond, Wash). In other embodiments, these applications take the form of small apps running on mobile devices operating mobile-oriented operating systems such as iOS (from Apple Inc.), WINDOWS PHONE (from Microsoft Corporation), or ANDROID (from Google Inc. of Menlo Park, Calif.). One of the major differences between these two embodiments is that the web server provides the entire user interface to the browser in the first embodiment, while the applications or apps in the second environment will typically implement much or most of the user interface locally and then use the dedicated data server to populate the interface with data appropriate for the user. In other cases, the applications or apps provide only a portion of the user interface, with the data server 10 implementing much of the user interface in effectively the same manner as a web server.

The various parties identify themselves to the dedicated platform server 10 through a login process, and the server 10 presents to the user (sometimes in conjunction with a local app) an interface that is specific to the users 20, 30, and 40 identified during login. Using known technologies, a computing device that has previously logged into the sever 10 can be identified at a later time using cookies, and the log in process can be skipped. The computerized system 10 stores data 50 about the users including relationships that exist between the user data elements. This data 50 could be stored in the same physical memory 14 as the program 16, or it could be stored in a separate location accessed by the computerized system 10 over a data bus or a computer network. In most embodiments, this data 50 is stored in one or more organized databases, such as a first database to manage information about users and their preferences and a second database to search and maintain real estate listing data. This data 50 also includes real estate listings that are searched and accessed by the users.

In an embodiment disclosed in more detail in the related applications incorporated above, buyers 20 who desire to research real estate listings found in data 50 are entered into the system 10. Data about the buyers 20 is stored in the database 50, and associated with data about their particular agent 30. That agent 30 works with a particular lender 40, which means that data about that agent 30 in the database 50 is in turn related to data about the particular lender 40. The buyer 20 (with or without help from their agent 30) may define search criteria with which to search the real estate listing database 50. However, the desired listing data 50 will not be delivered to the buyer 20 before the lender 40 activates the buyer's search criteria. This activation usually occurs only after the financial information about the buyer 20 is shared with the lender 40, allowing the lender 40 to approve the financial aspects of the buyer's search criteria. After reviewing the real estate listings delivered to the buyer 20 after activation, the buyer 20 can identify a property as a selected property. The selected property may be a preferred or favorite property that has made the “short list” that the buyer 20 is considering for purchase. In some embodiments, the buyer 20 can select a property for inclusion in a group of properties even if the property is not being considered as a property for purchase. For instance, the buyer 20 may wish to create a group of properties that contain “great kitchens,” or “decorating faux pas” that can then be shared and commented on by others using the system. In some embodiments, the buyer 20 may be able to create a plurality of property groupings with each group of properties having a different unifying theme. In the current description, properties that are selected for grouping are referred to as “favorites” even though the buyer 20 may define a different meaning for the selected group of properties. The buyer 20 can also store notes concerning these properties in the data 50 maintained by the dedicated platform server 10. The associated agent 30 and lender 40 through their interface to the dedicated platform server 10 can see these notes. The buyer 20, agent 30, and lender 40 can also communicate about those properties through the dedicated platform provided by the computerized system 10.

In one embodiment of the present invention, the potential buyer of real estate 20 can choose to share information about some or all of their favorite properties with friends, relatives, and co-workers. In one embodiment, this sharing takes place through a social networking platform (or SNP) that is operated on servers 60 that run separately from the dedicated platform servers 10. These SNP servers 60 operate similar to the dedicated platform servers 10, in that the SNP servers 60 operate with a processor 62 controlled by a program 66 residing in physical memory 64. Also like the dedicated platform servers 10, the SNP servers 60 can operate as web servers interacting with browsers on a user computer, or data servers interacting with dedicated social networking applications operating on a user mobile device. The potential buyer 20 can provide information about their identity on the SNP servers 60 and express a desire for the dedicated platform servers 10 to share information about their preferred properties with some or all of their contacts (or friends) on the social networking platform 60.

The dedicated server 10 identifies the contact information for the selected friends of the buyer 20, and then sends a message to those friends 70. This message is generally created using application programming interfaces (APIs) provided by the social networking platform 60. The message indicates that the potential buyer 20 would like the opinion of the friends 70 about specific real estate properties that the buyer 20 is considering. If the friends 70 decides to assist the buyer 20, the friends 70 utilize an “SNP app” 18 created by the provider of the dedicated platform 10 for this purpose. The SNP app 18 provides a front end to the data 50 accessed by the servers 10 that support the dedicated platform. In some embodiments, the SNP app 18 would be downloaded to the computers operated by the SNP friends 70 and executed on web browsers operating on those computers as part of the user interface to the social networking platform 60. In other embodiments, mobile devices running apps created by the social networking platform request access to the SNP app 18 through the social networking platform 60, and the programming of the SNP app 18 is then provided to the mobile device. In FIG. 1, this SNP app 18 is shown as being stored in the memory 14 of the dedicated platform server 10. In practice, the SNP app 18 could be stored in the memory 64 of the SNP server 60 and be provided when accessed by the computing devices used by SNP friends 70. This SNP app 18 will access data 50 managed by the dedicated platform server 10 and will accept data input from the SNP friends 70 that will be stored in the data store 50.

Note that the SNP app 18 can operate on a mobile device or on a full, general-purpose computer. This code 18 is referred to as an “app” merely because it runs in the context of the interface provided by the social networking platform server 60. Consequently, the term “app” in this context should not be considered to limit this code to software that operates on mobile devices.

The friends 70 operate the SNP app 18 inside of a window (or “canvas”) of the user interface provided by the social networking platform 60. This SNP app 18 will allow the friends 70 to review pictures and information about the various properties selected by the potential buyer 20 that are stored in data 50. In addition, the friends 70 will be able to add comments to a conversation within the SNP app 18 for that property. The potential buyer 20 will receive notification of comments made by their friends 70 through either the notification procedures provided by the social networking platform 60 or the notification provided by the dedicated platform 10. The buyer 20 can then respond to these comments, either through the same SNP app 18 running on their account on the social networking platform 60, or through an interface provided by the dedicated platform 10. All comments and other messages input through the SNP app 18 are stored on data 50 managed by the dedicated platform servers 10. This allows all of the comments entered through the SNP app 18 by the potential buyer 20 and their friends 70 to be viewed either through the real estate SNP app 18 running through an interface to the social networking platform 60 or through the dedicated platform 10.

The agent 30 and lender 40 associated with potential buyer 20 through the data 50 will also be able to see these communications, again either through the interface provided by the dedicated platform 10 or through their accounts on the social networking platform 60 while running the SNP app 18. In this way, agents 30 and lenders 40 using the dedicated platform 10 can monitor and participate in conversations that the potential buyer 20 is having with their friends 70 concerning their real estate search, even when the buyer 20 and the friends 70 are having the conversation while using the social networking platform 60.

In addition, friends 70 invited by the potential buyer 20 to participate in this process will be presented with the opportunity to directly contact the agent 30 or the lender 40 associated with the potential buyer 20. This allows the friends 70 the opportunity to obtain information about the home buying process from either service provider 30, 40. The friends 70 can even request that the agent 30 enroll them into the dedicated platform 10, after which the lender 40 would then activate their search criteria so that the friends 70 can also search real estate listings via the dedicated platform 10.

In one embodiment, the dedicated platform 10 will maintain in its database 50 contact information concerning the friends 70 invited by the buyer 20. This contact information can be included in the pipeline of potential clients that is maintained by the dedicated platform 10 for both the agent 30 and the lender 40.

The SNP app 18 can be designed so that the buyer 20, agent 30, and/or lender 40 can access the full capabilities of the dedicated platform 10 while operating on the user interface provide by the SNP servers 60. For example, the buyer 20 could use the SNP app 18 to create search criteria, review real estate listings, and communicate with their agent 30 and lender 40.

In another embodiment, the dedicated platform server 10 contains programming 19 that operate in connection with a second social networking platform 80. By providing multiple SNP Apps 18, 19, friends 70, 72 that prefer to communicate over different social networking platforms 60, 80 can contribute to a single conversation about a buyer's home buying experience. In FIG. 1, SNP Friend 3 (72) prefers to communicate over a different social networking platform 80 than the platform 60 used by Friends 1 and 2 (70). Since all the data 50 relating to the conversation is stored by the dedicated platform server 10, and the SNP Apps 18, 19 allow access to this data 50 through the different SNP platforms 60, 80, a single conversation is shared between all parties.

FIG. 1 shows a single buyer 20, agent 30, and lender 40 interacting with the system 10. In the real world, two or more individuals frequently learn about the home buyer process together, do an initial search for a house together, talk to an agent 30 and a lender 40 together, and final select and purchase a house together. To accommodate this reality, one embodiment of the present invention links multiple buyers 20 together, effectively forming a team of separate buyers 20 that works together. These buyers 20 would have a separate identity in the system 10, but would share property searches and conversations about properties. Each buyer 20 in the team would be able to contribute separately to a conversation, and their contributions would be separately identified to the other parties 30, 40, 70, 72 to the conversation. Nonetheless, the conversations would be linked to the team of buyers 20, such that any conversation contribution made by anyone 20, 30, 40, 70, 72 would be seen by all members of the buying team. Furthermore, it would also be possible to have multiple agents 30 or multiple lenders 40 working together as a team. Multiple agents 30 within a single agency might work with a buyer 20 to sell a home, and may participate in conversations about a property together much like a couple buying a home together.

In FIG. 1, a lender call center representative 42 is shown that works with a lender 40 as a team member. The call center representative 42 would assist a lender 40 when dealing with agents 30 and buyers 20 using the system 10. For instance, the call center representative 42 could monitor conversations initiated by buyers 20, and could contribute to these conversations on behalf of the lender 40. In one embodiment, the call center representative 42 could monitor and participate in the conversations of buyers 20 associated with a great plurality of lenders 40. In some embodiments, these contributions would be made in the name of the lender 40. In most cases, the comments of the call center representative 42 would be general in nature. When a more specific answer requires a direct comment from the lender 40, the call center representative 42 could prompt the lender 40 to add to the conversation directly.

Similarly, it is also possible that contributions to conversations by the lender 40 could be automated by the system 10. These contributions would be initiated on the occurrence of a triggering event. The triggering event could be a comment added to the conversation by a particular party containing a particular word or phrase. For instance, the system 10 could be programmed to identify the words “what is the current interest rate” (or similar phrases like “can you tell me the current interest rate” and “what are today's mortgage rates”) in a comment by anyone as a trigger for a particular message. The message may say “call me and I can let you know today's mortgage interest rates”, or it may integrate other data found in the system 10 by actually providing the current interest rate directly in the message. These automated conversation comments would be identified as coming from the lender 40, and may or may not be identified in the conversation as being an automated response from the lender 40. The triggering event may also be some other event in the system 10. For instance, the system 10 may allow the agent 30 to indicate when a house showing has been scheduled for a buyer 20. The scheduling of this event or the date of the house showing could form a trigger for an automated conversation message from the lender 40. Such automated responses could also be provided by the system 10 for the agent 30.

As disclosed in related application 10/187,207, it is possible for a system like system 10 to track communications between the agent 30 or lender 40 and the buyer 20. Prompts are provided by the system 10 to encourage either the agent 30 or lender 40 to contact the buyer 20. These prompts can alternate, so that after the agent 30 makes a communication to the buyer 20 the system 10 will prompt the lender 40 to make a communication. When the lender 40 then communicates with the buyer 20, the system prompts the agent 30 to make a new communication. Contributions to the shared SNP conversation count as a communication. For example, if the lender 40 is being prompted to communicate with the buyer 20 and contributes to an SNP conversation, the system 10 will stop prompting the lender 40 and start prompting the agent 30. In some embodiments, the prompt will be withheld by the system 10 if the buyer 20 has recently received a communication from the party that would have been prompted. In some embodiments, even automated contributions and contributions by team members such as the call center representative 42 count as communications that alter the prompting behavior of the system 10.

Because the communications between the agent 30 and lender 40 with the buyer 20 are stored in data 50 maintained by the system 10, the system 10 can aggregate this data to understand how individual agents 30 and lenders 40 are using the system 10. For instance, reports can be generated indicating the frequency with which an individual agent 30 or lender 40 contributes to the conversations of the buyers 20. The reports can also indicate whether there is a consistent time delay between a buyer 20 comment to the conversation and a replying comment from the agent 30 or lender 40. Agents 30 or lenders 40 that do not contribute significantly, or who consistently comment only after a delay of multiple days could be identified by the report. These agents 30 or lenders 40 can receive additional training on the use of the system 10 and the importance of keeping up the conversations with buyers 20. Furthermore, lenders 40 that work with multiple agents 30 can compare the behavior of their agents 30, and focus their energies on those agents 30 that are actively participating in the system 10 with their buyers 20.

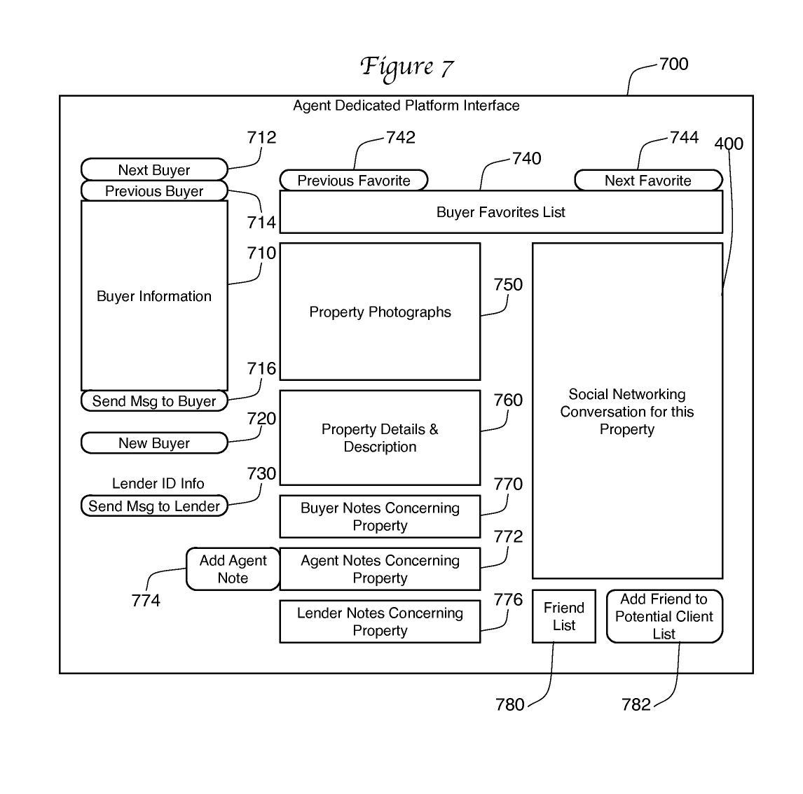

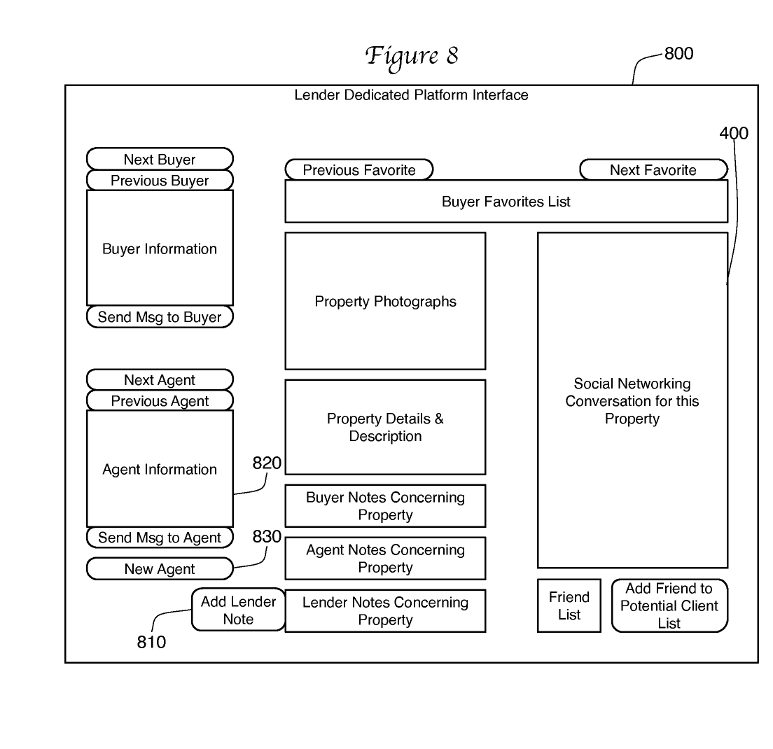

Finally, FIG. 1 shows a strategic business source 90 also communicating with the computerized system 10. Strategic business sources 90 are described in more detail in connection with related U.S. Pat. No. 8,095,457. As explained in that patent, a strategic business source 90 can be any party that may be of use to the buyer 20 in addition to the agent 30 and lender 40, such as a home inspector or moving company. Alternatively, the strategic business source 90 may be any party who would be willing to recommend that buyers 20 participate in the system 10 with a particular lender 40. In the preferred embodiment, the strategic business source 90 is not another agent 30 or lender 40. The strategic business source 90 participates in the system 10, and can view and contribute to the conversations maintained by the data 50 about the home buying experience of the buyer 20. The interface used by the strategic business source 90 to participate in a conversation is similar to the interfaces described below for the agent and lender in connection with FIGS. 7 and 8, respectively, below.

### Implementation of System 10

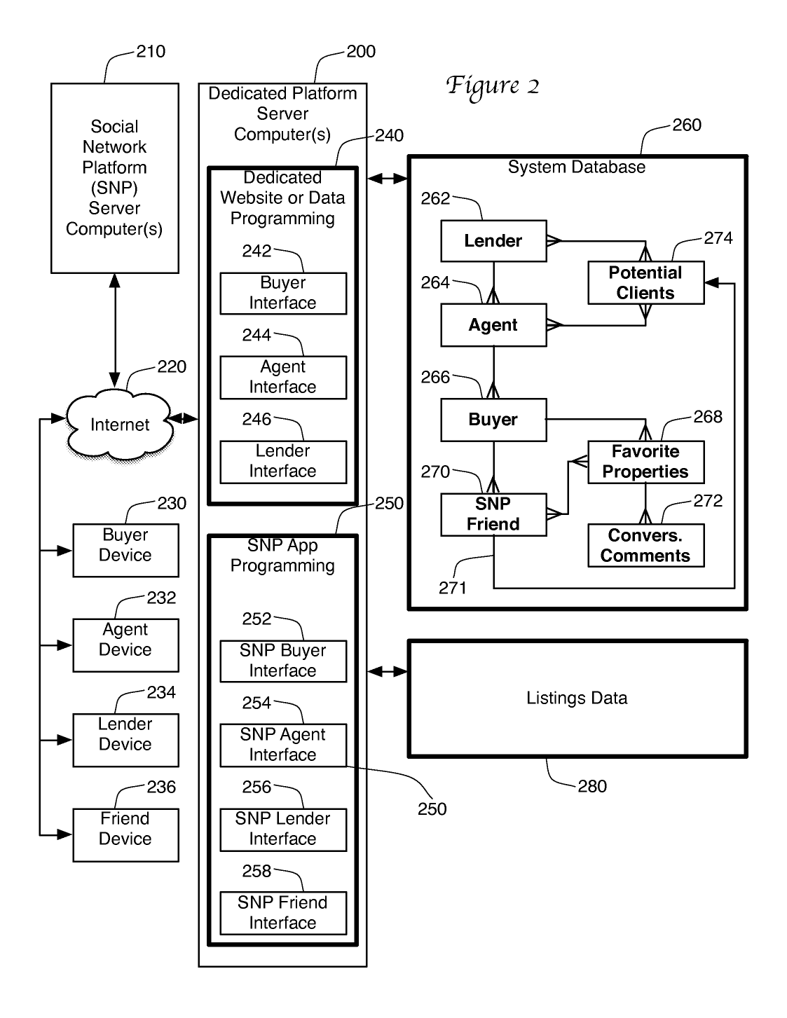

The computerized system 10 is capable of storing information about all of the parties that use the system 10. In the preferred embodiment, this information is stored in a database 260 managed by one or more server computers 200, as shown in FIG. 2. The information about the parties can be stored in pre-defined fields in a database table (or database objects in an object-oriented database environment) within the database 260. FIG. 2 shows the database with tables or objects for lenders 262, agents 264, buyers 266, favorite properties 268, SNP friends 270, conversation log entries (or “comments”) 272, and potential clients 274. The dedicated platform server(s) 200 also access listing data 280, which identifies real estate properties that are available for purchase. This listings data 280 can be provided by third parties, such as a regional multiple listing service (or MLS). The listings data 280 could be integrated into the same database 260 used to maintain data 262-274, or this data 280 could be hosted by a third party data provider.

The database 260 tracks relationships between each of the data entities 262-274, which are shown using crow's foot notation between the entities in FIG. 2. For instance, FIG. 2 shows that multiple agent records 264 can be associated with a lender record 262, but only a single lender record 262 is associated with any one agent record 264. This reflects the fact that the database 260 associates each agent 30 using the system 10 with a single lender 40. Similarly, the fact that buyers 20 are associated with a single agent 30 in the system 10 is implemented by associating buyer records 266 in the database 260 with only a single agent record 264. Because each buyer record 266 is associated with a single agent record 264, and each agent record 264 is associated with a single lender record 262, the database 260 also ensures that each buyer 20 is associated with a single lender 40. It is this lender 40 that must activate the search criteria for a buyer 20 before a buyer 20 may access desired real estate listings. Similarly, each friend 70 is associated with a buyer 20 by associating SNP Friend records 270 in the database 260 with a single buyer record 266. The database can associate multiple favorite property records 268 with a buyer record 266, which is used to allow a buyer 20 to share their favorite properties with friends 70 through the SNP system 60. Contributions to the conversation about a particular property 268 are stored in the database as a conversation log entry 272. Finally, when friend records 270 are created in the database for a buyer record 266, contact information from the friend records 270 are used to supplement a potential client list maintained by the system 10 for the agent 30 and lender 40. This is shown in FIG. 2 by arrow 271, which shows that data from the SNP friend record 270 is used to populate potential client data records 274, which are in turn linked with lender and agent records 262, 264. In particular, the friends 70 identified by a potential buyer 20 become potential clients for the agent 30 and lender 40 that are associated with that buyer 20 in the database 260.

One benefit of using the database 260 is that the system 10 is able to track how each party uses the system 10. Steps taken by a buyer 20 when reviewing or commenting on a property can be recorded in the database 260 and shared with the other parties that are associated with that buyer 20. In this way, notes input into the system about a property record 268 are immediately viewable by the agent 30 or lender 40 that have records 264, 262, respectively, in the database associated with the buyer record 266. Furthermore, steps taken by the buyer's friends 70 during interaction with the buyer 20 or with the proprieties 268 using the system 10 can also be recorded into the database 260. As explained below, agents 30 and lenders 40 can interact with the friends 70 using the system 10 and perhaps develop additional potential client leads among these friends 70. The system 10 may recall that a friend 70 really liked a particular house, which might prompt an agent 30 to contact that friend 70 to see if they were interested in looking at the house personally. Thus, information about a friend 70 and their activities on the system 10 will be stored in the database 260. The database 260 will recognize these activities as relating to a particular friend record 270 that, in turn, is associated with a particular buyer record 266. When that same friend 70 becomes a potential buyer 20 of the system, the information in the database 260 concerning the friend record 270 will be used to populate a new buyer record 266. Alternatively, the role of an individual within the system 10 could be maintained by the database 260, meaning only that the role for that individual's database record will be switched from that of a “friend” to that of a “buyer.” Regardless of the implementation details, the interactions that a friend 70 has with the system 10 will continue to remain accessible to the parties 20, 30, 40, 70, 90 using the system 10 even after the friend 70 becomes a buyer 20.

FIG. 2 should not be taken to indicate that the data entities 262-274 in system database 260 need to be implemented exactly as shown, with each entity 262-274 in the Figure implemented as a single database table or object. Rather, FIG. 2 merely indicates that one or more database entities are created within database 260 to track this information. It is well within the scope of the prior art to implement this type of data using a variety of entity architectures.

Web server programming 240 operating on the dedicated platform server computer 200 uses this data to implement the computerized system 10. The website programming 240 operates on a processor (such as processor 12 show in FIG. 1) to generate the various interfaces used by the system 10. In particular, web programming 240 defines how to create a buyer interface 242, an agent interface 244, and a lender interface 246 using the data in the database 260 and in the listings data 280. This programming allows the web server 240 to transmit over the Internet 220 the buyer interface 242 to browser software operating on a computer 230 for the benefit of a buyer 20. Similarly, the web server 240 can present an agent interface 244 to a browser operating on an agent computer 232, and a lender interface 246 on a browser operating on a lender computer 234. The computers 230-234 can be traditional personal computers, or can be any other type of computing device capable of presenting a web-based interface including a smart phone or a tablet or netbook computer. Alternatively, the web server programming 240 could be replaced with applications running on remote devices 230-236 and programming on the server computer 200 that respond to data and other queries from these devices 230-236 with the requested information.

In addition, SNP App programming 250 found on the dedicated server computer 200 can also generate an SNP buyer interface 252, an SNP agent interface 254, and an SNP lender interface 256 These SNP interfaces 252, 254, 256 are presented when a user accesses the SNP app 18 through one or more SNP server computers 60, 210 over the Internet 220. Part of these interfaces are contained in programming within the SNP app 18, which could be stored at the SNP computers 210 and downloaded to the buyer, agent, and lender computers 230-234. However, all interaction between this downloaded programming and the data in database 260 and listings data 280 is controlled by additional SNP app programming 250 operating on the dedicated platform server computers 200.

### Buyer Dedicated Platform Interface 300

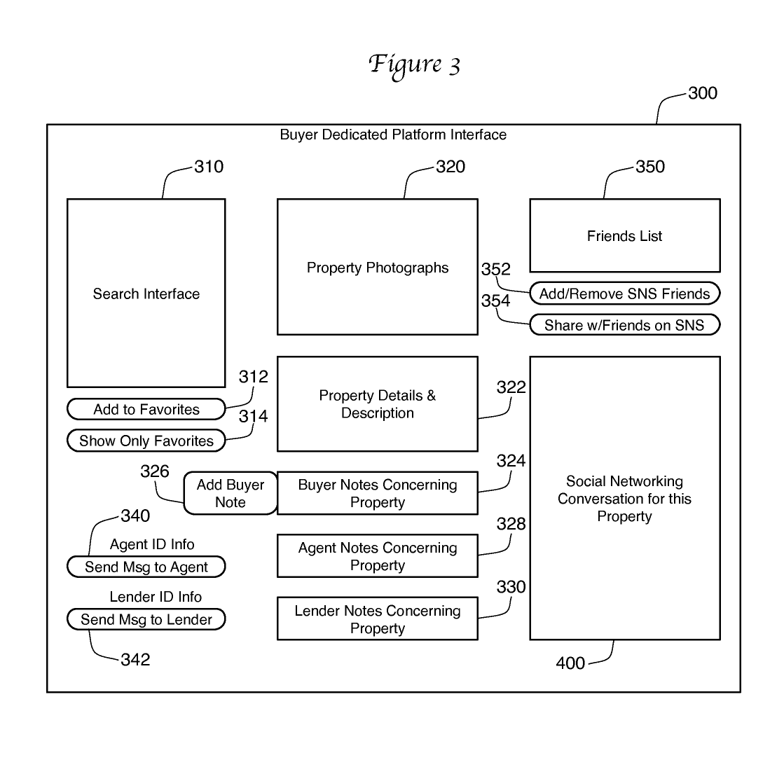

FIG. 3 shows one embodiment 300 of a buyer interface 242 presented by dedicated platform programming 240 when a buyer 20 accesses the system 10. As explained above, this interface 300 can be created, for example, by operating the dedicated platform server computers 200 as a web server providing web pages to a browser, or by providing a dedicated application operating on a computing device such as a smartphone that requests and receives relevant data from the server computers 200.

This interface 300 includes a search interface section 310 that allows a buyer 20 to input search criteria. In some embodiments, the search interface 310 also lists the real estate properties from the listings data 280 that meet the search criteria. The buyer 20 may identify one property from the search interface 310, such as by selecting the property with a mouse or other pointing device. The buyer dedicated platform interface 300 will then display one or more photographs 320 of the selected property as well as a description and other details 322 for that property. If a buyer 20 particularly likes the currently selected property, the buyer 20 can select the property as a favorite by selecting button 312. This identifies this real estate listing as a favorite property 268 in the database 260. The buyer 20 can also elect to show only favorite properties 268 in the search interface 310 by selecting button 314. As explained above, the buyer 20 can group properties by different categories other than by which properties are a “favorite.” For example, the buyer may create a group of properties that have “great landscaping” and another group for “favorites.” In this case, interface element 312 would allow the buyer 20 to select a group (such as by using a pull-down user interface element) and then add the current property to that grouping.

The buyer 20 is able to view notes that they have created concerning the property at element 324. The buyer 20 enters new notes 324 by selecting interface button 326 and then inputting the content of the note. In addition, notes 328 created about the property by the agent 30 and similar notes 330 created by the lender 40 are displayed on interface 300. If the buyer 20 wishes to communicate with the agent 30 or lender 40 to whom they have been assigned, they may select interface button 340, 342 which opens a communication mechanism. In one embodiment, selecting buttons 340, 342 allows the buyer 20 to input text to the agent 30 or lender 40, which is then delivered as a message through the computerized system 10. In other embodiments, such communication takes place through standard e-mail, and the buttons 340, 342 trigger a new e-mail message to the appropriate party 30, 40.

Interface element 350 lists the friends 70 that the buyer 20 has identified that use the social networking platform 60. If the buyer 20 wishes to add or remove a friend 70 from this list 350, they merely select button 352 and an interface allows the additional or removal. In the preferred embodiment, the addition of friends to the friends list 350 takes place using an application programming interface (or API) provided by the social networking platform 60. The dedicated platform 10 identifies the buyer 20 as a member of the social networking platform 60, and requests the social networking platform 60 to provide a list of buyer's friends on the site 60. This list is then presented when the buyer 20 selects button 352, allowing the buyer 20 to add friends to the list 350 based on their existing friends at the social networking platform 60.

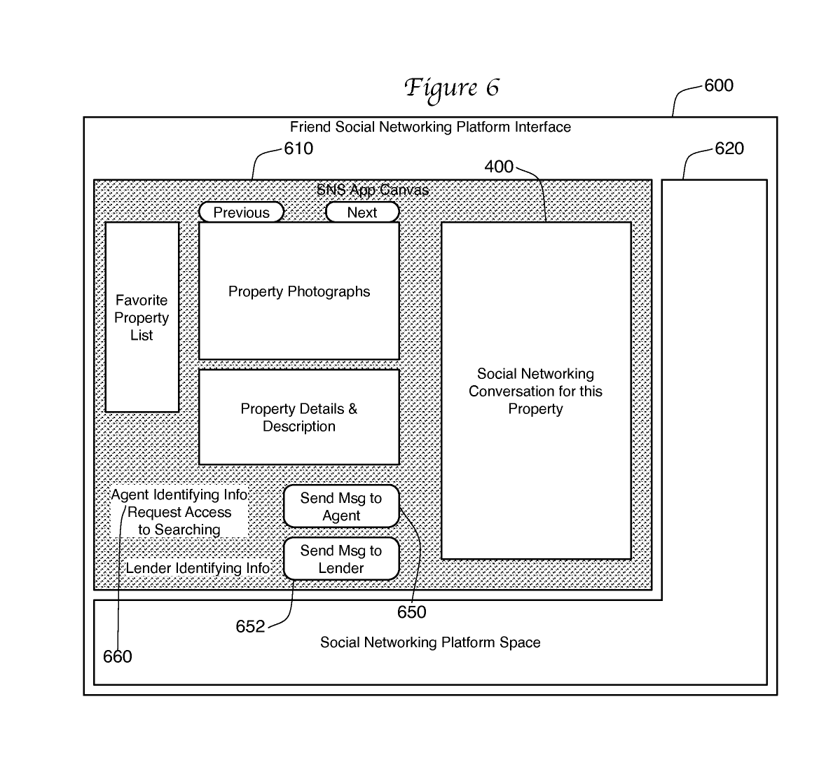

Button 354 is used to share the currently selected property from the search interface 310 with the friends on the friends list 350. As explained above, this causes either the dedicated platform 10 or the social networking platform 60 to send a communication to the friends 70 on list informing them that the buyer 20 wishes to receive their input on a property. If the friend 70 desires to help and is not already using the SNP app 18, the friend 70 would simply agree to use the app 18 on the social networking platform 60. The friend 70 can then access their account on social networking platform 60, run the SNP app 18, and then view the property information as described below in connection with FIG. 6.

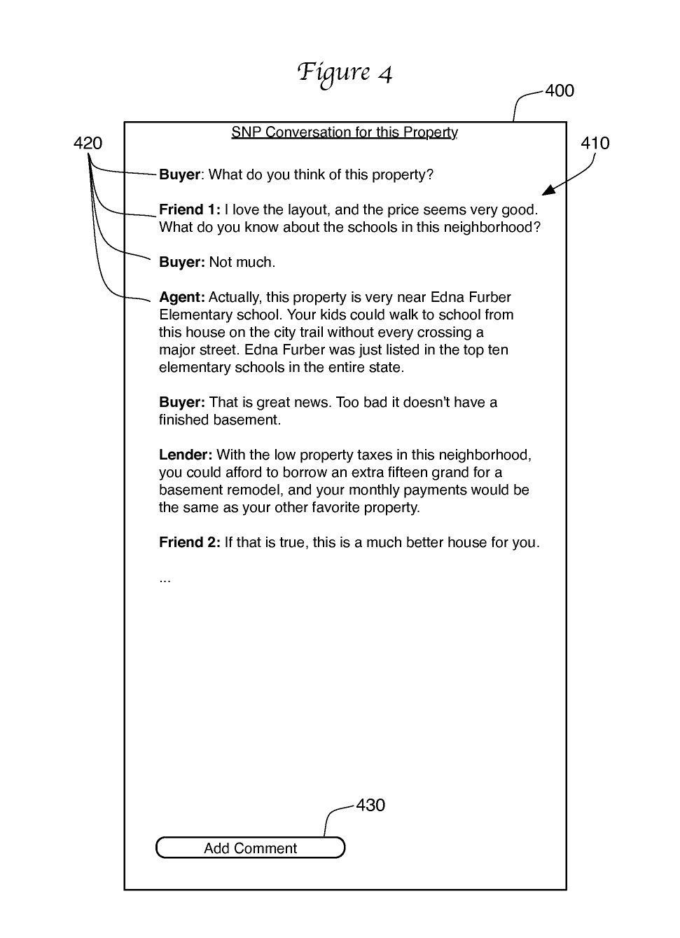

In their use of the SNP app 18, the friends 70 are encouraged to participate in a social networking conversation for a particular property. This conversation is presented to the buyer in interface 300 through conversation interface 400, which is shown in more detail in FIG. 4. This interface 400 presents a conversation 410 concerning a property between two or more of the users 20, 30, 40, 70 of the system 10. The conversation 410 consists of a plurality of comments 420, with each comment made by a single user 20, 30, 40, or 70. In FIG. 4, the conversation 410 starts with a comment 420 created by the buyer 20, which is followed by comments by a first friend 70, the buyer 20, the agent 30, the buyer 20, the lender 40, and finally a second friend 70. To add a new comment 420 to the end of the conversation 410, the user simply selects the add comment button 430. Each of these comments 420 are contained in the conversation log data elements 272 described above in connection with FIG. 2. These data records 272 are associated both with a particular favorite property record 268, which is shown in the crow's foot notation of FIG. 2. In addition, these records 272 are associated with the user 20, 30, 40, 70 that created the comment (record 266, 264, 262, and 270). By storing in database 260 the text of each comment, the user that created the comment, and the time that the comment was created, it is a simple matter to recreate a conversation 410. It is usually desired to limit a conversation 410 about a property to those comments 420 made by users 20, 30, 40, 70 associated with one particular buyer 20. This is because most buyers 20 are only interested in comments 420 about a property that are made by users that are known to the buyer 20.

### SNP Interfaces 500, 600

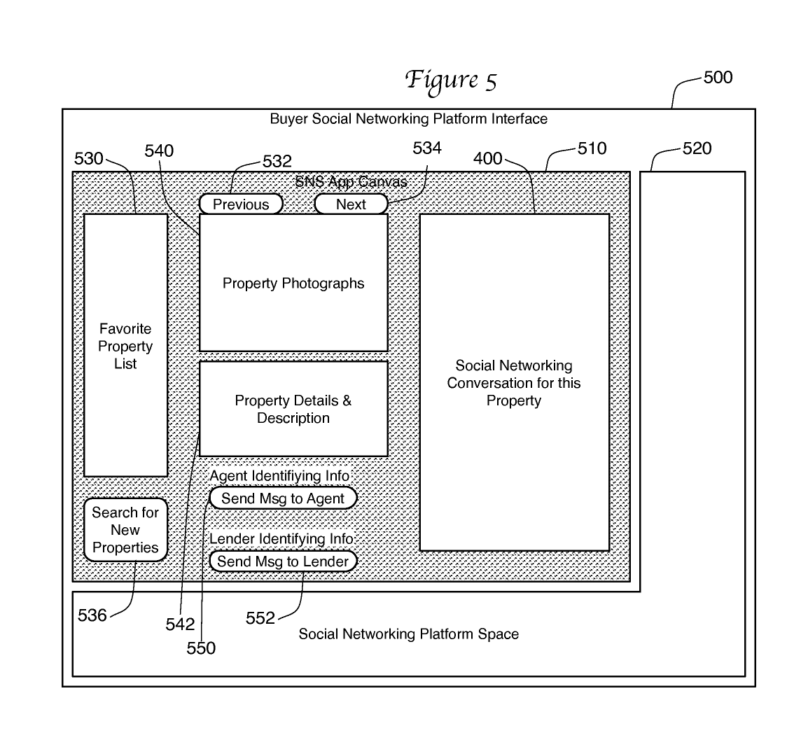

As mentioned above, the buyer 20 can also access data 50 maintained by the dedicated platform servers 10 through the social networking platform servers 60 via SNP app 18. The interface 500 through which this occurs is shown in FIG. 5. The interface 500 is provided by the SNP servers 60, perhaps working in conjunction with a local application or mobile device app, and is dominated by the SNP App Canvas 510. In this description, the term canvas is intended to cover that portion 510 of an interface 500 provided by a social networking platform 60 that is available for use by a third party app such as SNP app 18. In some embodiments, the canvas 510 may constitute the entire interface 500. In other embodiments, the canvas 510 makes up less than the entire interface 500, with the remaining portion of the interface 500 constituting social networking platform space 520.

The SNP app 18 manages the canvas 510 along with the SNP app programming 250 residing on the dedicated platform server computer 200 shown in FIG. 2. In effect, the canvas 510 constitutes the SNP Buyer interface 252. Since this computer 200 is the same computer, or is running cooperatively with the computer that provides the buyer interface 242 for the dedicated platform 240, the interface components of canvas 510 can be the same as the interface components of the buyer dedicated platform interface 300. FIG. 5, however, shows a canvas 510 with a simplified interface when compared with FIG. 3, which is frequently appropriate when the SNP app canvas 510 must share screen space with the SNP space 520.

This canvas 510 is shown with a favorite property list 530 that allows a user to select a favorite property. The user may manually select a property from this list 530, or may use the previous and next buttons 532, 534 to page through this list 530. In situations where a buyer 20 is able to store properties in additional categories, list 530 will include a user interface element that allows the user to select the category that determines which properties will be displayed in list 530. Photographs 540 and detailed information 542 about the currently selected favorite property are also shown on the app canvas 510. One way to simplify the canvas interface 510 is to remove the search interface that creates the buyer search request, which means that the buyer 20 will need to select a “search for new properties” button 536 and open a new canvas interface for searching properties if a new search is desired. Alternatively, it is possible that the SNP app canvas 510 doesn't allow the buyer 20 to search for new properties. In this latter case, the buyer 20 must use interface 300 to access the dedicated platform 10 directly in order to conduct a new search.

In one embodiment, the buyer 20 can use the SNP app canvas interface 510 to communicate with their agent 30 and their lender 40 by selecting buttons 550, 552, respectively. Although it is not shown in FIG. 5, selecting these buttons 550, 552 can either create a new interface for managing these communications, or can create space within the SNP app canvas interface 510 directly for the buyer 20 to view previous communications and to create new communications with their agent 30 and lender 40.

The right side of the canvas 510 in FIG. 5 contains the SNP conversation 400 about the selected property. This conversation is the same conversation 400 that was presented in interface 300 and described in connection with FIG. 4. As explained above, the conversation 410 is created by aggregating the comments 420 stored in database records 272 that originated with the buyer 20 and with the agent 30, lender 40, and friends 70 that are associated with that buyer 20 in database 260.

FIG. 6 shows another social networking interface 600 accessed through SNP servers 60. This interface 600 is presented to a friend 70 of the buyer 20 that is accessing the SNP app 18 to comment on the buyer's favorite properties. Like interface 500 shown in FIG. 5, the friend's social networking platform interface 600 includes an SNP app canvas portion 610 and a social networking platform space 620, with the SNP app 18 and the dedicated platform server 10 being responsible for providing the canvas 610 portion of the interface 600. The SNP App Canvas 610 presented to a buyer's friend 70 is very similar to the SNP app canvas 510 presented to the buyer 20. In particular, the favorite (or other category) property list 530, the previous and next buttons 532, 534, the property photographs 540, and the property details and description 542 are identical. The friend 70 is not authorized to search the property listings data 280, so the search for new properties button 536 is not found on canvas 610. The friend's SNP app canvas portion 610 also includes the SNP conversation 400, which takes on the same appearance shown in FIG. 4.

The friend canvas 610 does include a button 650 to send a message to the agent 30 and a button 652 to send a message to the lender 40, which perform similar to the same buttons 550, 552 described in connection with FIG. 5. Note that these buttons 650, 652 allow the friend to communicate with the agent 30 and lender 40 that is associated with their friend (buyer 20) in database 260. This allows the friend 70 to ask questions of these professionals 20, 30—questions that may pertain to the favorite property being selected by the buyer 20 or questions that may relate to the friend's own house buying process. One reason to encourage the friends 70 to participate in the conversation 400 concerning a favorite property of the buyer 20 is to engage the friends into conversations with the agent 30 and lender 40. Such conversations may encourage direct communication with these professionals 30, 40, which could lead to additional business. To further encourage direct communication with the agent 30 working with the buyer 20, the friend SNP app canvas 610 explains to the friend 70 at location 660 that they must request the agent 30 to add them to the system 10 as a potential buyer if they wish to search the property listings available through system 10. Once added to the system 10, the friend would also need to have their search request activated by the lender 40 before receiving the desired search results from the listings data 280. Also, as mentioned above, friends 70 that are added to the database 260 and are associated with one of their buyers 20 can automatically be added to the potential customer data 274 associated with the agent 30 and lender 40.

### Agent and Lender Dedicated Platform Interfaces 700, 800

FIG. 7 shows one embodiment 700 of an agent interface 244 presented, at least in part, by the dedicated platform server computers 200 when agent 30 accesses the system 10. This interface 700 includes buyer information 710 that contains information about the buyer 20 that is stored in the system database 260, such as the buyer's name and address, financial information, and search criteria. The agent 30 using interface 700 may be associated with many buyers 20 in the database 260, and can move from one associated buyer 20 to the next using the next and previous buyer buttons 712, 714. In other embodiments, a search interface (not shown in FIG. 7) would allow the agent 30 to search for a particular buyer 20 to display on interface 700. The agent 30 can send a message to the buyer 20, or view previous communications with the buyer 20 through button 716.

The dedicated platform agent interface 700 also allows the agent 30 to enter new buyers 20 into the system 10. This is accomplished by pressing button 720, which opens an interface that allows the agent 30 to enter data about the buyer 20 into a new buyer record 266 of database 260.

The agent 30 can also send messages or view previous communications made with the lender 40 with whom the agent is associated through button 730. As explained above in connection with buyer 20 communications with the agent 30 and lender 40, the send message buttons 716, 730 could open additional interfaces that allow the user to create and view communications, or could link to standard e-mail programs to allow e-mail communications.

The agent interface 700 also lists those properties that the buyer 20 has indicated to be their favorites (or are within another buyer-defined category) at list 740. To view information about a particular property, the agent 30 can select a property from this list 740, or can use the previous and next favorite buttons 742, 744 to navigate through the list. The agent dedicated platform interface 700 then displays one or more photographs 750 of the property selected in list 740, as well as a description and other details 760 for that property.

The agent 30 is able to view notes that they have created concerning the property at element 722 The agent 30 enters new notes 722 by first selecting interface button 774 and then inputting the content of the note. In addition, notes 772 created about the property by the agent 30 and similar notes 770, 776 created by the buyer 20 and lender 40, respectively, are displayed on interface 700.

Interface element 780 lists the friends 70 that the buyer 20 has identified that use the social networking platform 60. As explained above, one embodiment of the present invention automatically adds new friends 70 for the buyer 20 to the potential client list of the agent 30 and lender 40 representing that buyer 20. In another embodiment, friends are manually entered into these potential client lists, such as by selecting a friend 70 from list 780 and clicking the add friend to potential client list button 782.

The agent interface 700 to the dedicated platform 10 also includes the SNP conversation interface 400 for this property. This interface element 400 is the same conversation interface 400 described above. By placing this element 400 on the agent interface 700, the agent 30 is able to both view and participate in the social networking conversation 400 between the buyer 20 and their friends 70. This is true even though the friends 70 are accessing the conversation 400 through the canvas 610 that is created by SNP app 18 and presented through the social networking platform 60 used by the friend 70, while the agent is accessing the conversation 400 through a dedicated platform interface 700 operated by a dedicated platform server 10.

The lender 40 also accesses the dedicated platform 10 through a dedicated platform interface, namely the lender dedicated platform interface 800 shown in FIG. 8. This lender interface 800 is very similar to the agent interface 700 described in connection with FIG. 7. Like the agent interface 700, the lender interface allows the lender 40 to preview buyer information, select a particular buyer to see that buyer's favorites list, and then select a particular property to view property information for that property. The lender interface 800 also allows the lender 40 to see notes about the property entered by the buyer 20, agent 30, and lender 40. The lender 40 can add notes to be shared with the buyer 20 and agent 30 by clicking the add lender note button 810. The lender 40 can also view and participate in the social networking conversation about this property through conversation interface element 400. By participating in the conversation 400, the lender 40 is given an opportunity to meaningfully interact with the buyer 20 early in the buyer's home search process. This should lead to an increased likelihood that the buyer 20 will turn to the lender 40 for the buyer's mortgage needs. In addition, participation in the conversation 400 will allow the lender 40 to interact with friends 70 of the buyer 20, which may also lead to increased business opportunities. As with the agent interface 700, the lender interface 800 includes a button to add one or more of the buyer's friends 70 to the lender's potential client list.

The only significant difference between the interfaces 700, 800 is the ability of the lender to view information 820 about a variety of agents. The difference stems from the fact that, in one embodiment of the present invention, the database 260 associates each lender 40 with multiple agents 30, but each agent 30 is associated with only one lender 40. In FIG. 8, the lender 40 is also given the opportunity to add new agents 30 to the system 10 via the new agent button 830.

### Method 900

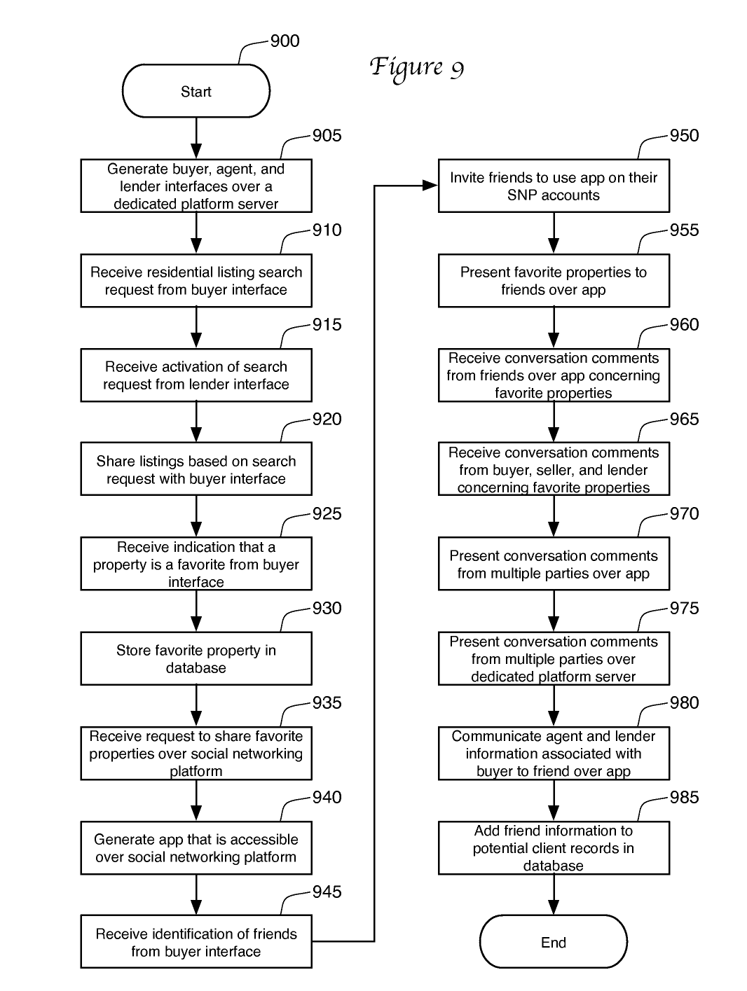

In one embodiment of the computerized system 10, the database 260 is used to implement the method 900 shown in the flowchart of FIG. 9. The method 900 starts at step 905, with the system 10 generating a buyer interface 242, an agent interface 244, and a lender interface 246 for a dedicated platform running on dedicated platform server computers 10, 200. This allows the buyer 20, agent 30, and lender 40 to interact with dedicated platform 10. In step 910, the servers 10, 200 receive from the buyer interface 242 operating on the buyer device 230 a specific request to search residential listing data 280. In one embodiment, no real estate listing data is returned to the buyer interface 242 until the buyer search request is activated. In these embodiments, search request activation for a specific buyer 20 can generally occur only through a specific lender interface 246 operating on a lender computer 234. More particularly, only the lender interface 246 presented to the specific lender 40 identified by lender data 262 that is associated with data 266 for the specific buyer 20 can activate that buyer's search criteria. The receipt of this activation through the lender interface 246 takes place in step 915 of method 900. Once the search request is activated, the listings that respond to the search request are provided to the buyer interface 242 in step 920.

In step 925, the buyer 20 indicates that a particular property discovered through their search of the listings data 280 is a “favorite property” (or fall into another buyer-defined category). At step 930, information about that property is stored in data element 268 of the database 260 to ensure that the property is remembered by the system 10 as one of the favorite properties of buyer 20. If buyer 20 wishes to engage in a conversation with her friends 70 about this property over a social networking platform 60, the dedicated platform servers 10, 200 will receive an instruction to this effect in step 935. One way to express this desire is for buyer 20 to select dedicated button 354 that is presented on the buyer's interface 242. In order to share property information with friends 70 over social networking platform 60, it is necessary to create an SNP app 18 that can operate through the interfaces provided by social networking platform 60 and yet access servers 10 and data 50. This SNP app 18 is generated in step 940. Obviously, the SNP app 18 will usually be generated in step 940 before the previous steps shown in the flowchart of FIG. 9 so that the SNP app 18 is ready to be used when requested by the users. At step 945, the buyer interface 242 identifies the SNP friends with whom the buyer 20 desires to share this property information. In the buyer interface 300 shown in FIG. 3, this occurs by adding and removing SNP friends through list 350 and button 352. Once again, the identification of friends in step 945 could occur before the previous steps shown in flowchart 900.

At step 950, the identified friends 70 are invited to view the favorite properties of buyer 20. This invitation is sent by server 10, and can be sent through the application programming interfaces of the social networking platform 60. Alternatively, the invitation can be sent outside the social networking platform 60, such as through standard, Internet based e-mail. On the basis of this invitation, these friends 70 begin to use the SNP app 18 through a user interface (such as interface 600) provided by the social networking platform 60. The SNP app 18 then presents, at step 955, those favorite properties that the buyer 20 elected to share with these friends 70. At this point the friends 70 may contribute comments to the social networking conversation about this property. These comments are received by server 10 at step 960 and stored in database element 272. Additional comments from other friends 70 and from the buyer 20, agent 30, and lender 40 can also be received at step 965 and stored in the database 260. These comments can be received through the interfaces 252-258 generated through the SNP app 18, or through the interfaces 242-246 of the dedicated platform programming 240.

At step 970, these comments are organized and presented as a conversation about the property through SNP app 18, typically through the SNP App Canvas 510, 610 that forms part of the social networking platform interface 500, 600. In addition, the same conversation can be presented through the dedicated platform interfaces 300, 700, 800 that are presented to the buyer 20, agent 30, and lender 40 outside of the social networking platform 60 (step 975). The conversation interface 400 shown in FIG. 4 shows one method of organizing a conversation 410, where comments 420 are arranged chronologically from oldest to newest. Other types of organizations of the conversation 410 (such as from newest to oldest, or grouped by author of the comment) would be within the scope of the present invention. Furthermore, the above description of the conversation interface 400 describes a system where all comments 420 shown in a conversation 410 relate to a single property. An alternative embodiment would allow all comments 420 made about any of the properties in the favorites list of a buyer 20 to be grouped into a single conversation 410 shown in interface 400.

At step 980, the SNP app 18 also presents information about the agent 30 and lender 40 that are associated with the buyer 20. This allows friends 70 that use the SNP app 18 to see contact information about these service providers 30, 40, and to directly communicate and request information from the agent 30 and lender 40. As shown in FIG. 6, it can also be useful to include in the interface 600 shown to friends 70 a mechanism (such as buttons 650, 652) to start a private conversation with the agent 30 or lender 40. This provides a simple mechanism for the friend 70 to initiate the process of registering with the agent 30 and lender 40 on system 10 to become a buyer 20 in their own right and receiving the right to search for real estate listings on site 10.

Finally, at step 985, the system 10 assists in adding information about a buyer's friend 70 to the potential client lists maintained for the agent 30 and lender 40 associated with that buyer 20. As described above, this can be accomplished by copying data from friend records 270 in database 260 automatically into potential client records 274 on creation of each friend record 270. Obviously, it is not always necessary to copy data into a separate record, as this could lead to unnecessary duplication of data in the database 260. One could achieve the same result by simply linking the lender record 262 and agent record 264 to the SNP friend record 270 in a manner that recognizes that the friend record 270 is a potential client of the agent 30 and lender 40. It is not necessary for the creation of a new friend record 270 to automatically lead to the inclusion of that friend 70 in the potential client lists maintained for the agent 30 and lender 40. In FIG. 7, for example, the “add friend to potential client list” button 782 requires that the agent 30 or lender 40 manually add each friend 70 as a potential client. Once the information is added to the potential client lists, the method 900 shown in FIG. 9 ends.

### Conversation Topics 1010

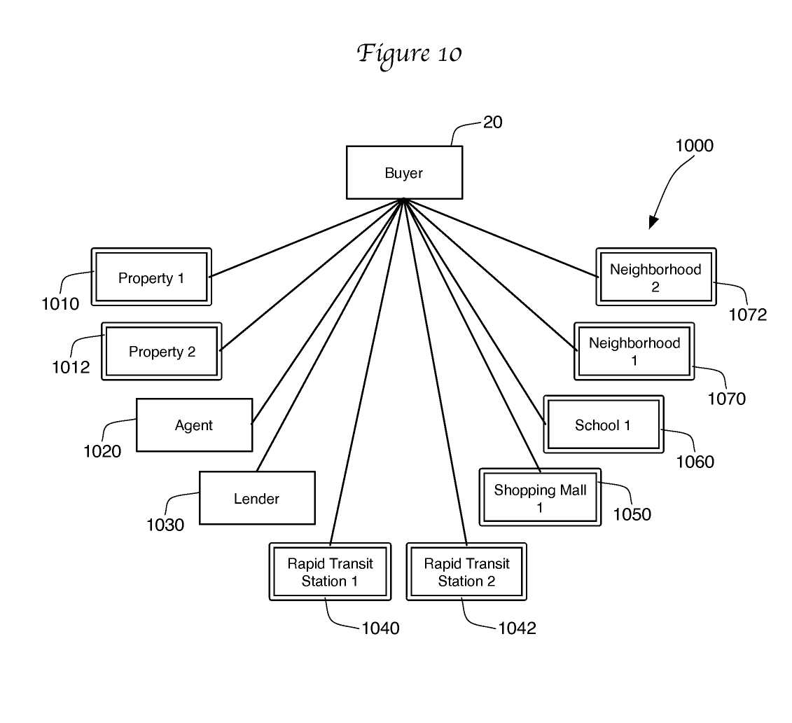

In the embodiments of the present invention described above, the separate conversations 400 engaged in by the various parties were organized according to properties. A user selected a property from the favorites list of the buyer 20, and data about that property was displayed in the user's interface 300, 500, 600, 700, 800 next to a conversation 400 about that property. In other embodiments, however, conversations 400 do not have to be centered on a particular property from the favorites list of the buyer 20. In FIG. 10, a single buyer 20 is associated with ten different conversations 1000, each having a different topic. Some of these conversations 1000 may be focused on individual properties such as was described above, as is true of conversation 1010 (about “Property 1”) and conversation 1012 (about “Property 2”). In addition, a conversation 1020 has been generated about the agent 30 working with the buyer 20 (“Agent”). In this conversation 1020, friends 70 may ask the buyer 20 whether they have enjoyed working with the agent 30, or whether the agent 30 has been too busy to give personal attention to the buyer 20. A separate conversation thread 1030 could be created around the lender 40 (“Lender” on FIG. 10).

In addition, a buyer 20 may want comments from friend 70 relating to certain amenities in various neighborhoods they are considering. For instance, part of the criteria for selecting a home may be the safety and convenience of the closest rapid transit station. In FIG. 10, the buyer 20 is participating in separate conversations 1000 about a first rapid transit station (conversation 1040) and a second rapid transit station (conversation 1042). Conversation 1050 is centered on a particular shopping mall that is near some of the properties under consideration, while conversation 1060 concerns the quality of a particular school. Finally, it is possible that the topic of conversations 1000 could be entire neighborhoods under consideration, as is the case with conversations 1070 and 1072.

In one embodiment, there is no strict enforcement of these topics. In this case, nothing prevents a user from contributing a comment about School 1 in the conversation 1012 concerning property 2. Nonetheless, it can be helpful to organize conversations around topics other than individual properties. Furthermore, even conversations 1010 and 1012 that are about individual properties need not be limited to conversations about properties found on the favorites list of the buyer 20. If a friend 70 wants to point the attention of the buyer 20 to a particular property not on their favorites list, this embodiment will allow the friend 70 to create that conversation topic.

In FIG. 10, conversations concerning a topic with a specific geographic location (namely conversations 1010, 1012, 1040, 1042, 1050, 1060, 1070 and 1072) are indicated with a double-lined box. Topics 1020 and 1030 that are not associated with a geographic location are shown with a single box. One embodiment of the system 10 identifies the geographic location associated with a conversation topic, and tags that conversation with that location. Other embodiments may identify individual comments within a conversation that relate to a geographic location and then tag the individual comment with that location. By so doing, it is possible to have a mobile app that accesses the dedicated platform 10 and uses the geographic location tags to provide indicators on a real-time map shown on the mobile device. A buyer 20 could display the map, and see that they are currently near property 2, which they have not seen before, as well as school 1 and rapid transit station 1. The buyer 20 could then visit these locations while reviewing the relevant conversations 1012, 1060, and 1040. Alternatively, the mobile app could notify the user whenever their physical location was near one of the geographic tags.

### Secure and Controlled Social Networking Conversations

One of the primary advantages of the above-described embodiments is that an agent 30 or lender 40 can participate in a conversation with third parties 70 over a social networking platform 60 without leaving the controlled environment of the dedicated platform servers 10. The content of these conversations is stored in data 50 that is controlled and maintained by the dedicated platform servers 10. Employees of the social networking platform 60 will not access this data 50, which means that the dedicated platform 10 has complete control over the security of these conversations. In some embodiments, the SNP App 18 that provides access to these conversations through the social networking platform 60 can encrypt all communications between the app 18 operating on the computing device of the third party 70 and the dedicated platform server 10, further enhancing the security and privacy of the communications. In the embodiment described in FIG. 1, encryption is probably not warranted, as the purpose of the communication is to engage in an open conversation with multiple parties about the home buying process of the buyer 20.

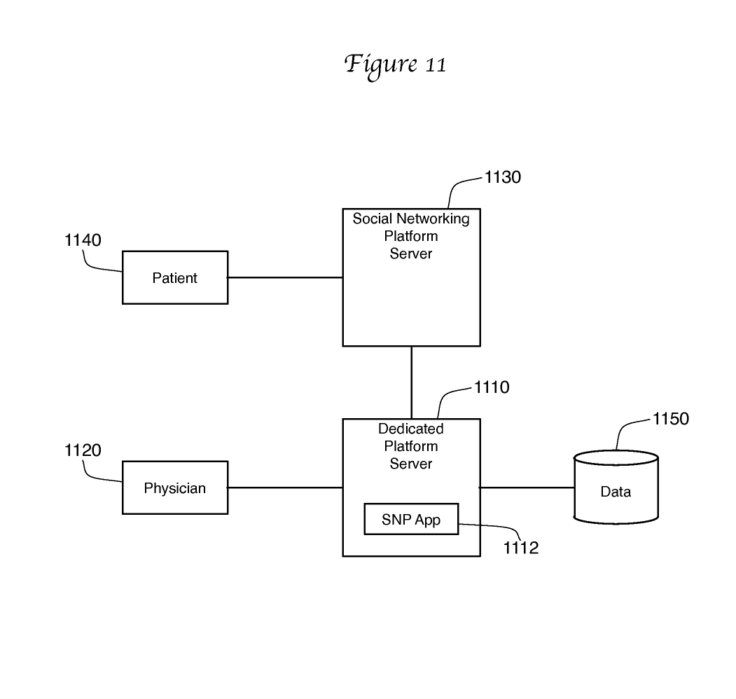

The embodiment shown in FIG. 11, however, is more appropriate for the use of encryption. In this embodiment, a physician 1120 has access to a dedicated platform server 1110 that operates similar to the dedicated server 10 described in connection with FIG. 1. Data 1150 is stored and maintained by the dedicated platform server 1110. An SNP app 1112 is provided that allows a third party, such as patient 1140 to access and contribute to the data 1150 while using an interface provided by a social networking platform 1130. In this case, the app 1112 allows only two parties to contribute to a conversation, namely the physician 1120 and the patient 1140. These communications are preferably encrypted while passing between the devices used by the parties 1120, 1140 and the dedicated platform server 1110. This means that even though the patient 1140 is communicating through an interface provided by a social networking platform 1130 (such as through a web site or a dedicated app on a mobile device), the communication is kept private even from the servers and the operating staff of the social networking platform 1130. It would even be possible for the physician 1120 to be communicating using the SNP app 1112 through the social networking platform 1130, or even through a second, distinct social networking platform. In this way, secure two-way conversations can be established using a secure process over a social networking platform, where the content of the conversations is stored by a dedicated platform server 1110 while remaining inaccessible to third parties. The encryption process can use public and private encryption keys, or other techniques that are know in the prior art to established secure connections between two parties over a wide area network.

In addition to maintaining security, the fact that the conversation comments passes through the dedicated platform server 1110 allows the dedicated platform server 1110 to filter content in those conversations. For example, many businesses will not allow employees to participate on social networking platforms in an official capacity because there is no ability to monitor those employees. As a result, businesses are not taking full advantage of the opportunity to use social networking platforms to converse with existing clients and meet new clients. Using the embodiment disclosed in FIG. 11, the dedicated platform server 1110 could limit the topics of conversation allowed for one of the parties, such as physician 1120. This could be done by key word filtering, where the dedicated platform server 1110 would reject comments added to a conversation that contained a key word. This could also be accomplished by defining a set of available comments and limiting a physician's comment to those pre-defined comments. Of course, these comments need not be static comments, as complex programming could allow a great variety of content and syntax. Alternatively, the physician 1120 could be governed by guidelines that are not proactively enforced by the dedicated platform server 1110. Instead, the physician would be aware that the comments that they contribute to a SNP conversation will be stored by the dedicated platform server 1110 and would be available for review after to fact to ensure compliance with the guidelines. Finally, a mixture of these different control techniques could be implemented simultaneously. Whatever the form of the control, the use of a dedicated platform server 1110 allows an employee such as physician 1120 to communicate with clients and potential clients through a social networking platform 1130 in a secure and monitored environment.

In order to accomplish this control, the dedicated platform server 1110 needs to understand the content of the encrypted messages that are sent over the social networking platform server 1130 so that the content of the messages can be stored as data 1150 and possibly filtered. In most embodiments, this is accomplished by establishing a direct encrypted communications link between the dedicated platform server 1110 and the SNP App 1112 of one or both of the parties 1120, 1140. This means that the dedicated platform server 1110 would, for example, receive an encrypted message from the patient 1140 that passes through the social networking platform server 1130 and then decrypt that message before passing the message on to the physician 1120. If the physician 1120 is communicating directly with the dedicated platform server 1110, the communication between the physician 1120 and the server 1110 need not be encrypted. However, if the physician 1120 is also using an SNP App 1112 over the social networking platform server 1130 (or another social networking platform), the dedicated platform server 1110 would re-encode the message before passing the message on to the physician 1120. The re-encoded need not use the same encryption key or keys used by the SNP App 1112 providing the interface to the patient 1140. In other words, two different encryption communication paths are established, one between the patient 1140 and the dedicated platform server 1110, and one between the dedicated platform server 1110 and the physician 1120.

Another technique to accomplish this is to allow the dedicated platform server 1110 to monitor the communications between the parties 1120, 1140. An encrypted message from one party 1120 would pass uninterrupted, and without the need for re-encryption, over the dedicated platform server 1110 to the other party 1140. If the dedicated platform server 1110 has access to decryption keys needed to decrypt these messages, the server 1110 may copy the messages being transmitted, decrypt them without interrupting or slowing down the transmission of the messages, and then save the decrypted messages in data 1150.

In the above description of FIG. 11, a one-to-one communication between a physician 1120 and a patient 1140 is provided. Typically, patient 1140 would be an existing client of the physician 1120 who knew that they could communicate over the social networking platform 1130 using the SNP app 1112. One additional benefit of this embodiment is that an employee such a physician 1120 could engage in secure and monitored conversations with new and potential clients. For instance, existing client 1140 could recommend that their friend (not shown in FIG. 11) use the SNP app 1112 to contact their physician 1120, ask a few questions, and set up an appointment. The SNP app 1112 would assist the friend in selecting and identifying the physician 1120, and then initiate a private, secure conversation with the physician 1120 over the social networking platform 1130.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A server comprising:
a) at least one computer, each computer having a processor that processes programming instructions;
b) non-transitory computer readable memory containing data in a database and database programming to manage the database, the database comprising:
i) an agent record containing information about a real estate agent;
ii) a buyer record containing information about a potential buyer of real estate working with the real estate agent, the buyer record being associated with the agent record;
iii) a selected property record containing information about residential real estate selected by the buyer, the selected property record being associated with the buyer record;
iv) a friend record containing information about an individual that uses a social networking platform and who was selected by the buyer, the friend record being associated with the buyer record;
v) a friend conversation record containing a fried conversation comment and being associated with the friend record, and
vi) an agent conversation record containing an agent conversation comment and being associated with the agent record;
c) non-transitory computer readable memory containing social networking platform app programming for creating an application that operates within a social networking platform, the app programming creating a friend social networking app interface within the social networking platform, the friend social networking app interface displaying:
i) data from the selected property record, and
ii) a friend conversation interface to the data in the friend and agent conversation records; and
d) non-transitory computer readable memory containing dedicated platform programming for creating a dedicated platform accessible over a wide area network, the dedicated platform having
i) an agent interface for presenting information from the buyer record and for presenting an agent conversation interface to the data in the friend and agent conversation records, the agent interface being transmitted via the dedicated platform outside the social networking platform.

2. The server of claim 1, wherein the database further contains:
vii) a lender record containing information about a mortgage lender, and
viii) a lender conversation record containing a lender conversation comment and being associated with the lender record;
further wherein the friend conversation interface and the agent conversation interface also displays data from the lender conversation record.

3. The server of claim 2, wherein the dedicated platform further has:
ii) a lender interface for presenting information from the buyer and agent record, and also for presenting a lender conversation interface to the data in the friend, agent, and lender conversation records, the lender interface transmitted via the dedicated platform outside the social networking platform.

4. The server of claim 1, wherein the database further contains:
vii) a buyer conversation record containing a buyer conversation comment and being associated with the buyer record, and
further wherein the friend conversation interface and the agent conversation interface displays data from the buyer conversation record.

5. The server of claim 4, wherein the friend conversation interface displays data from the friend, agent, and buyer conversation records in a chronological order.

6. The server of claim 4, wherein the app programming further creates a buyer social networking app interface that displays:
i) data from the selected property record, and
ii) a buyer conversation app interface to data in the friend, agent, and buyer conversation records.

7. The server of claim 6, wherein the dedicate platform further has:
ii) a buyer interface for presenting a buyer conversation interface to the data in the friend, agent, and lender conversation records, the buyer interface transmitted via the dedicated platform outside the social networking platform.

8. The server of claim 7, wherein the buyer interface further includes a friend input interface for identifying friends on the social networking platform, wherein the dedicated platform programming creates new friend records in the database when a new friend is identified via the buyer interface on the dedicated platform.

9. The server of claim 8, wherein the database further contains:
viii) a lender record containing information about a mortgage lender, and
ix) a lender conversation record containing a lender conversation comment and being associated with the lender record;
further wherein the friend conversation interface, the agent conversation interface, and the buyer conversation app interface, and the buyer conversation interface also displays data from the lender conversation record.

10. The server of claim 9, wherein the dedicated platform further has:
iii) a lender interface for presenting information from the buyer and agent record, and also for presenting a lender conversation interface to the data in the friend, agent, buyer, and lender conversation records, the lender interface transmitted via the dedicated platform outside the social networking platform.

11. The server of claim 10, wherein the dedicated platform programming further creates a potential client record using data in the friend record.

12. The server of claim 11, wherein the friend record is created when the dedicated platform programming receives a create potential client request from the agent interface, and further wherein the potential client record is associated with the agent record within the database.

13. The server of claim 2, wherein the database further comprises a strategic business source record containing information about a strategic business source working with one of the residential real agent and the mortgage lender, and a SBS conversation record containing a strategic business source conversation comment and being associated with the strategic business source record.

14. The server of claim 13, wherein the dedicated platform further has a strategic business source interface for presenting information from the buyer, agent, and lender records to the strategic business source.

15. A computer implemented method comprising:
a) generating a buyer dedicated platform interface at a dedicated server computer operating a dedicated platform;
b) accepting from the buyer dedicated platform interface a search request for residential property listings;
c) displaying the results of a search performed according to the search request over the buyer dedicated platform interface;
d) accepting from the buyer dedicated platform interface a request to mark a property listing as a selected property;
e) creating a selected property record in a database;
f) generating an app that is embedding into a social networking platform via an API provided by the social networking platform, the app providing a friend social networking app interface;
g) storing friend conversation comments received from the friend social networking app interface in the database;
h) generating an agent dedicated platform interface at the server computer through the dedicated server computer;
i) storing agent conversation comments receiving from the agent dedicated platform interface in the database;
j) presenting both the friend conversation comments and the agent conversation comments in a friend unified conversation interface over the friend social networking app interface; and
k) presenting both the friend conversation comments and the agent conversation comments in an agent unified conversation interface over the agent dedicated platform interface.

16. A computer implemented method comprising:
a) providing over a computerized network a first social networking app that communicates with a social networking platform server utilizing APIs, the first social networking app providing a first interface to a first user;
b) providing, from a dedicated platform server and over the computerized network, a second interface to a second user;
c) receiving at the first interface a first conversation message for the second interface;
d) encrypting the first conversation message at the first social networking app;
e) transmitting the encrypted first conversation message over the social networking platform server such that the social networking platform server does not have access to the unencrypted first conversation message;
f) receiving and decrypting the encrypted first conversation message at a central server operating separately from the social networking platform server;
g) transmitting, from the central server, the first conversation message to the second interface;
h) displaying the first conversation message at the second interface;

17. The computer implemented method of claim 16, wherein the central server stores the first conversation message in a database.

18. The computer implemented method of claim 16, wherein the second interface further transmits a second conversation message to the central server, and the central server then encrypts the second conversation message before transmitting the second conversation message to the first social networking app for display on the first interface.

19. The computer implemented method of claim 18, wherein the central server examines and filters content of a third conversation message sent from the second interface to the first interface, so as to block transmission of at least a portion of the third message based on the examined content of the third message.

20. The computer implemented method of claim 16, wherein the second interface is provided through a second social networking app that communicates with the social networking platform server utilizing APIs, and further wherein the central server re-encrypts the first conversation message before transmitting the first conversation message to the second interface.

21. The computer implemented method of claim 20, wherein the encryption used to encrypt the first conversation message from the first interface to the central server uses different encryption keys than the encryption used to encrypt the first conversation message from the central server to the second interface.
